(19) United States
(12) Patent Application Publication
(10) Pub. No.: US 2010/0219173 A1
(43) Pub. Date: Sep. 2, 2010

(54) VIEWING WINDOW FOR THE ARRANGEMENT OF AN OPTICAL SENSOR AND/OR DETECTION SYSTEM IN A VEHICLE

(76) Inventor: Andreas Gruber, Lindenberg i. Allg. (DE)

Correspondence Address: RATNERPRESTIA, P.O. BOX 980, VALLEY FORGE, PA, 19482, US

(21) Appl. No.: 12/670,549

(22) PCT Filed: Jul. 25, 2008
(86) PCT No.: PCT/DE08/01213

§ 371 Date: May 11, 2010

(30) Foreign Application Priority Data
Jul. 26, 2007 (DE) 10 2007 035 027.0

(51) Int. Cl. B60L 1/02

(52) U.S. Cl. 219/203

(57) ABSTRACT

A viewing window for an optical sensor and/or detection system in a vehicle, wherein at least one viewing field of the optical system is defined within the viewing window. A window-heating device encircles the viewing field while the viewing field itself is designed to be free from integrated elements or surface-mounted elements.

### CROSS REFERENCE TO RELATED APPLICATIONS

This application is the U.S. national phase application of PCT International Application No. PCT/DE2008/001213, filed Jul. 25, 2008, which claims priority to German Patent Application No. 10 2007 035 027.0, filed Jul. 26, 2007, the contents of such applications being incorporated by reference herein.

### BACKGROUND OF THE INVENTION

The invention relates to a viewing window for the arrangement of an optical sensor and/or detection system in a vehicle, within the viewing window at least one viewing field of the optical system being defined.

In vehicle construction increasingly assistance systems known per se are used, which are based on an optical monitoring of the vehicle surroundings. For this purpose, for example optical cameras and/or sensor systems are used, which are arranged within the vehicle structure, and which gain optical access to the surroundings by a suitable viewing window. Such systems are the more powerful, the more they are protected against any type of optical interfering factors.

### SUMMARY OF THE INVENTION

It is an object of the present invention to indicate a viewing window of the type mentioned above, which ensures with an arrangement of an optical unit of an optical sensor and/or detection system in connection with the viewing window for example a maximum efficiency of the optical sensor and/or detection system.

A substantial thought of the invention is to define with a viewing window for an optical sensor and/or detection system in a vehicle within the viewing window at least one viewing field of an optical unit of the optical system and to encircle the viewing field with a window-heating device, while the viewing field itself is designed to be free from integrated elements or surface-mounted elements. Thus, the viewing field can be kept free particularly from icing and fogging by this window-heating device. In the viewing field itself, however, no elements disturbing the view are arranged. Consequently, by means of the invention interfering factors resulting from icing, fogging and the like can be eliminated, without simultaneously having to accept negative influences by heating agents arranged in the viewing field, such as for example wires.

In the scope of the present disclosure the following terminology is used by the way: A viewing window is a physical unit. The solid angle, which is detected or covered by the optical unit is a visual range of an optical unit. The viewing field is a portion of a viewing window, which in one form of embodiment of the described object comprises at least the projection of the visual range of an optical unit on a viewing window, arranged in a certain relative position to the viewing field, and which is adapted at least approximately in particular to this projection with regard to size, position and geometry; in one form of embodiment the viewing field is at least essentially identical with the projection of the visual range.

Here, the optical unit can be a camera, which is used for detecting the vehicle surroundings and for example in connection with an assistance system; here, this camera can work for example in the visible and/or in the infrared wavelength range, for example for a night vision system. In another form of embodiment the optical unit is a light source, for example an infra-red light source for a night vision system. In another exemplary form of embodiment this is an optical sensor such as for example a rain sensor, wherein in this case the given enumeration is to be understood as merely exemplary and by no means intends and cannot be conclusive.

The vehicle can be a road vehicle, for example a motor vehicle, but, for example also a rail vehicle.

In one form of embodiment of the viewing window a zone encircling the viewing field comprises a window-heating device, i.e. in particular not the entire viewing window outside of the viewing field is provided with a window-heating device. In a further development of this form of embodiment this zone represents a strip encircling the viewing field, the strip comprising for example a width of 5 mm to 30 mm.

In one form of embodiment the window-heating device comprises a heating pipeline, which takes in particular a meandering course around the viewing field. Here, a meandering course does not strictly mean the form of a rounded winding course, but also another course, in which the distance of the heating pipeline to the viewing field alternates in sections. Examples for this is a course in the type of an alternating rectangular function or a triangular function; some exemplary forms of embodiment are indicated below. In one exemplary form of embodiment the heating pipeline comprises a heating wire set into the window. In another exemplary form of embodiment the heating pipeline is arranged on a surface of the window, the heating pipeline being in particular glued or printed thereon.

The heating pipeline is for example a resistance wire, which is heated upon actuation with an electric current, and thus also heats the window on or in which it is arranged, so that for example ice defrosts and condensate evaporates in such a manner that a clear view through the window, unimpaired at least from the mentioned interfering factors, is ensured in the region of the viewing field.

In a further form of embodiment a black print is applied on the window in the region of the window-heating device. This has also the effect that disturbing lateral scattered light is suppressed on the optical unit.

In one form of embodiment the viewing field has a geometry, which corresponds at least approximately to the projection of the visual range of the optical unit on the viewing window. This visual range often has the form of a pyramid with a rectangular basis or a cone, which diverges with increasing distance from the optical unit, i.e. for example from the camera or the sensor. Thus, the viewing field of the viewing window has for example a rectangular, in particular square, or circular geometry, if the viewing window is vertical to the visual axis of the system, or the viewing field of the viewing window is in particular trapezoidal, ellipsoidal or egg-shaped, if the viewing window is sloped to the visual axis of the optical unit, as it would be the case for example in case of a windshield. Here, “egg-shaped” means in particular the form of an ellipse, which dimensions are increasingly elongated in one direction, the elongation factor increasing in particular in direction to the large main axis of the ellipse. An example for this is indicated below. Depending on the curvature of the window in the region of the viewing field these geometries can also be further distorted. Of course, the viewing field must not strictly correspond to the projection of the visual range, however, in certain forms of embodiment of the described object it is at least adapted to this projection with regard to position and/or size and/or geometry.

In this regard it is obvious to the person skilled in the art, that with a given arrangement of the optical unit relative to the viewing window, the viewing field should or must be dimensioned and arranged such that the projection of the visual range of the optical unit on the viewing window lies completely within the defined viewing field.

In one form of embodiment the viewing window comprises a viewing field, whose maximum dimensions are smaller than 10 cm×10 cm and are in particular smaller than 5 cm×5 cm. Among other things this measure is caused by the fact that the heating arranged next to the viewing field of the window comprises only a limited scope, without increasing the heating power into the immeasurable.

The viewing window is for example a window pane, in particular a windshield or a rear window, of a vehicle. Furthermore, it can also be a covering element for an optical unit of an optical system, such as for example a sensor or a camera, wherein the covering element can be for example also a headlamp glass, behind which at least one optical unit is arranged.

Furthermore, it is by no means compelling that the viewing window, in particular as a specially designed covering element, is transparent in the sense of a transparency in the visible wavelength range. Depending on the case of application a covering element of this type can also show transparency in the infrared or ultraviolet range, a color filter function, and/or can be characterized by a band-pass function, a long-pass function, a short-pass function and the like. In one form of embodiment the transmission characteristics in the viewing field differs from that of the residual viewing window.

The described embodiments of the object presented here can of course also be combined with each other.

Described and claimed is also a vehicle, which comprises a viewing window of the above described type.

An object of at least one embodiment of the present disclosure is further also a sensor and/or detection system, which comprises at least one optical unit, for example an optical sensor and/or a camera, as well as a viewing window of the type described above, whereby the viewing field of the window is dimensioned and the sensor and/or the camera is arranged such that the viewing field of the window provides an unimpaired optical passage for the visual range of the optical unit, i.e. for example of the sensor and/or the camera. Here, also the above described geometries of the viewing field of the window are of importance, which result from the geometry of the visual range of the sensor or the camera, the arrangement of the window relative to the alignment of the visual range and if necessary also of the curvature of the window in the relevant region of the viewing field. Further, also a vehicle is described and claimed, which comprises at least one sensor and/or detection system described here.

Further advantages and fields of application of the present invention result from the ensuing description taken in conjunction with the examples of embodiment represented in the drawings.

### BRIEF DESCRIPTION OF THE DRAWINGS

The drawings show in

FIG. 1 a schematic top view on a motor vehicle, which comprises a device in accordance with an embodiment of the invention;

FIG. 2 a first example for the arrangement of an optical unit with a certain visual range and a viewing window, as well as a viewing field defined on the viewing window;

FIG. 3 a second example for the arrangement of an optical unit with a certain visual range and a viewing window, as well as an associated viewing field defined on the viewing window;

FIG. 4 an example for the realization of the described object at the viewing window from FIG. 2; and

FIG. 5 an example for the realization of the described object at the viewing window from FIG. 3.

### DETAILED DESCRIPTION OF THE INVENTION

In the following same and/or functionally same elements can be provided with same reference numerals. The absolute values and measurements indicated hereinafter are only exemplary values and do not represent a limitation of the invention on such dimensions.

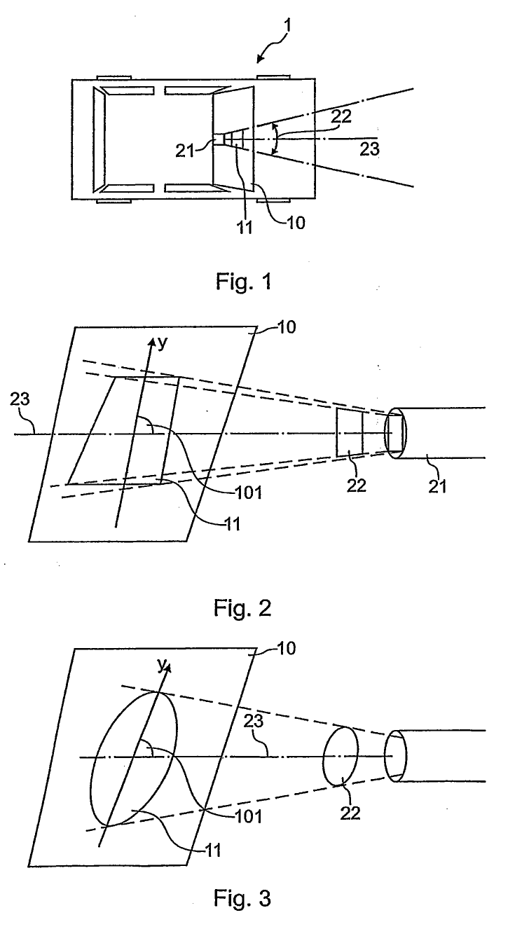

For illustrating the here described object a vehicle 1 is shown in FIG. 1. The vehicle 1 is provided with an optical sensor and/or detection system, which comprises an optical unit 21. The optical unit is for example an optical sensor, an image capture unit, for example a camera, or also a light source for a night vision system and the like. The optical unit comprises a visual range 22 and is arranged in the vehicle interior. The optical path of the optical unit within the visual range 22 passes through a viewing window of the vehicle, here in particular a window pane of the passenger compartment, for example the windshield 10. However, this can easily be also another cover, such as for example a headlamp glass, another light cover, or a cover for the optical unit, which is arranged at an appropriate place of the body shell. Here, the visual range 22 defines as a diffusion with the windshield 22 a viewing field 11. A visual range which in cross section is rectangular, also square, and divergent defines on a viewing window inclined towards the central axis 23 of the visual range a trapezoidal viewing field, as is shown in FIG. 2.

The representation in FIG. 2 shows an optical unit 21 with a visual range 22 square in cross section, the visual range diverging along the central axis 23 of the visual range. A viewing window 10 is inclined below an angle 101, which is different than 90°, against the axis 23 of the visual range. Thus, a square visual range once forms as a rectangle on the viewing window. Simultaneously, the visual range diverges with the distance from the optical unit 21. As a consequence, the dimension of the projected viewing field on the viewing window 10 decreases towards the axis referred to as Y, due to the inclination of the viewing window, and the viewing field on the viewing window is trapezoidal. By the way, the axis “Y” is merely illustrative and virtual; it must be imagined in plane of the viewing window 10, or respectively, if the viewing window is curved, as a tangent at that location, at which the central axis 23 of the visual range passes through the viewing window.

For the person skilled in the art it is directly and easily obvious that a corresponding distortion of the projection of the visual range results from a curvature of the viewing window in the region of the viewing field 11.

FIG. 3 shows this for a visual range 22 circular in cross section. When projecting on an inclined viewing window 10 an ellipse develops; however, due to the divergence of the visual range the ellipse is distorted in such a manner that their dimensions in the regions of the viewing window, which are more remote from the optical unit 21, are enlarged. That means, the ellipse actually resulting experiences an elongation due to the divergence of the visual range, the factor of the elongation increasing in the negative “Y”-direction of the shown Y-axis. Thus, an egg-shaped projection and thus for example an egg-shaped viewing field is created.

Again the person skilled in the art easily recognizes that from a curvature of the viewing window in the region of the viewing field 11 a corresponding distortion of the projection and of the geometry of the viewing field 11 results.

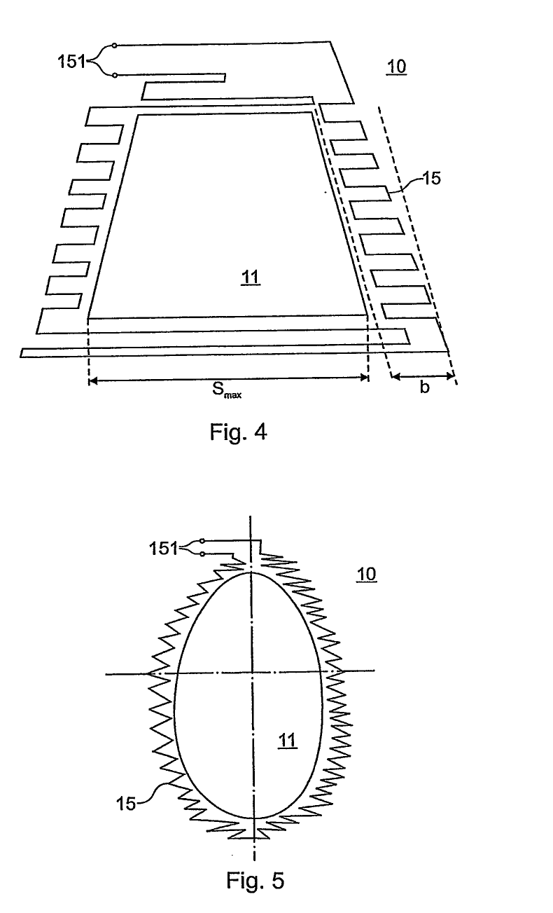

FIG. 4 shows a detailed representation of a first form of embodiment of the object described here. The viewing window 10 comprises a viewing field 11 for the transparency of an optical unit of a sensor and/or detection system. A window-heating apparatus 15 encircles the viewing field. In this example the device is a heating pipeline, which is printed, glued or set into the window. Furthermore, connection points 151 of the heating pipeline are shown. Via these connection points an electric current can be conducted through the heating pipeline 15, as a result of which it is warmed-up and it heats the viewing window. Frequently, in the region of the heating device also a so-called black print can be found on the window. Depending on the form of embodiment this black print is also useful in order to reduce or prevent the incidence of scattered light onto the optical unit. In the broad sense the heating pipeline takes a meandering course around the viewing field. Even if a meandering course generally means winding, looped arrangements, in this scope the term meander-shaped is also used to describe the pipeline course shown in FIG. 4. Generally, “meander-shaped” is to be understood in the scope of the present disclosure in the broadest sense and shall define a course of a heating pipeline, which is arranged around the viewing field with an alternating distance from the viewing field. Consequently, the heating device 15 is arranged in a strip-shaped zone surrounding the viewing field 11 and heats it directly, while by the heat conduction within the viewing window indirectly also the viewing field 11 is co-heated. Thus, the viewing field 11 can be kept free for example from ice or condensed water, without elements of a heating device, which disturb the free view, being arranged in the viewing field itself. As the heating of the viewing field 11 is based on heat conduction, the maximum dimension S_{MAX} of the viewing field is limited in one form of embodiment. In this case, the heated zone surrounding the viewing field 11 has a width b; the smaller it is, naturally the smaller is the entire influence of the heating device onto the appearance of the viewing window and on the view of the viewing window 10 outside of the viewing field 11.

In FIG. 5 a further example for a viewing window of the type indicated here is shown. The geometry of the viewing field results here in the manner shown above in connection with FIG. 3 from the arrangement of an optical unit not shown with a divergent visual range circular in cross section behind a viewing window, the viewing window 10 not being arranged commonly to the axis of the visual range. According to this, the viewing window is egg-shaped, more accurate, it has in the manner described above the form of a distorted ellipse. The heating device in turn surrounds the viewing field as a strip-shaped zone of a certain width. In all other respects the width of the heated zone is not necessarily constant, such as the width in the example of embodiment of FIG. 4 does not have to be constant. An arrangement with a heating device in such a manner that the width of the heated zone surrounding the viewing field is constant, is not absolutely an absurd form of embodiment. Also here, the heating device is a wire, which in a zone surrounding the viewing field is printed, glued or set into the viewing window or is otherwise arranged in suitable manner.

In the example of embodiment of FIG. 5 the heating pipeline is zigzag-shaped. In the scope of the present disclosure also this arrangement is to be understood as meander-shaped in the broader sense. Of course, also here a black print can be easily arranged in the region of the heating device.

The forms of embodiment described above can easily be transferred to other geometries of the viewing field than those represented. The region circumscribed by the heating device does not have to necessarily reproduce in each detail the geometry of the viewing field or the projection of the visual range of the optical unit. Also forms of embodiment can be provided in the scope of the invention, in which one viewing window comprises several viewing fields surrounded in the described manner by a heating device, which viewing fields may easily comprise different geometries and/or spectral transmission characteristics.

In one form of embodiment it is also absolutely possible that the region of the viewing window circumscribed by the heating device is larger by a certain degree than the viewing field. On the other hand, it goes without saying that the region occupied by the heating device shall not penetrate into the effective viewing window, or the projection of the visual range of the optical unit on the viewing window, respectively, in order not to impair the efficiency of the optical system or the optical unit, respectively.

Further, it is to be stressed again that the viewing window must not necessarily be a window of a passenger compartment; it may be also for example a lamp cover or a component, which is particularly provided as a cover of an optical unit. The window must also not be optically clear, in the sense of a transmission in the visible spectrum of the light. Adapted to the optical system the window can also comprise a spectral selective transmission. Here, the transmission must not strictly lie in the visible spectrum, but can also lie for example in the infrared region; the latter can be useful with a night vision device, in order to suppress interfering light.

In particular, the spectral transmission characteristics in the viewing field can also be different from that of the residual window or from the spectral transmission characteristics of other viewing fields arranged on the viewing window.

1.-14. (canceled)

15. A viewing window for an optical sensor and/or detection system in a vehicle, within the viewing window at least one viewing field of the optical system being defined, wherein a window-heating device encircles the viewing field, while the viewing field itself is designed to be free from integrated elements or surface-mounted elements.

16. A viewing window according to claim 15, wherein a zone surrounding the viewing field of the viewing window comprises a window-heating device.

17. A viewing window according to claim 16, wherein the zone represents a strip surrounding the viewing field, this strip having a width from approximately 5 mm to approximately 30 mm.

18. A viewing window according to claim 15, wherein the window-heating device comprises a heating pipeline which takes a meandering course around the viewing field.

19. A viewing window according to claim 18, wherein the heating pipeline comprises a heating wire set into the window.

20. A viewing window according to claim 18, wherein the heating pipeline is arranged on a surface of the window, the heating pipeline being glued or printed thereon.

21. A viewing window according to claim 15, wherein in the region of the window-heating device a black print is arranged on the window.

22. A viewing window according to claim 15, wherein the viewing field has one of the following forms: rectangular; square; circular; trapezoidal; ellipsoidal; egg-shaped.

23. A viewing windows according to claim 15, wherein the dimensions of the viewing field are smaller than approximately 5 cm×5 cm.

24. A viewing window according to claim 15 as a window pane of the vehicle.

25. A viewing window according to claim 24 wherein the window pane is a windshield or a rear window of the vehicle.

26. A viewing window according to claim 15 as a covering element.

27. A sensor and/or detection system, comprising an optical unit and a viewing window according to claim 15, the viewing field of the window being such dimensioned and the optical unit being such arranged that the viewing field of the window provides an unimpaired optical passage for the visual range of the optical unit.

28. A sensor and/or detection system according to claim 27 wherein the optical unit is an optical sensor and/or a camera.

29. A vehicle, comprising at least one sensor and/or detection system according to claim 27.

30. A vehicle, comprising at least one viewing window according to claim 15.
